(19) United States
(12) Patent Application Publication
(10) Pub. No.: US 2023/0245234 A1
(43) Pub. Date: Aug. 3, 2023

(54) INTEGRATED CASH NETWORK DECISION OPTIMIZATION PLATFORM

(71) Applicant: Sachin Sumant, Bridgewater, NJ (US)

(72) Inventor: Sachin Sumant, Bridgewater, NJ (US)

(21) Appl. No.: 18/131,904

(22) Filed: Apr. 7, 2023

Related U.S. Application Data
(60) Provisional application No. 63/351,417, filed on Jun. 12, 2022.

(51) Int. Cl. G06Q 40/06; G06N 20/00

(52) U.S. Cl. CPC G06Q 40/06; G06N 20/00

(57) ABSTRACT

The present invention discloses an integrated cash network decision optimization platform. The platform facilitates real time integrated cash and profit projections, budgeting, and forecasting using predictive, prescriptive, and cognitive (artificial intelligence) machine learning models combined with alert-based user decision planning process. The platform may also allow a user to apply unlimited what-if scenarios changing user assumptions, planned actions, and goals to evaluate impact. The platform converts cash related activity into a cash network to apply network optimization algorithms to maximize cash value and performance. The platform provides ability to build risk profiles and evaluate applicable external investments, financing, and operational products from integrated marketplace as part of scenario modelling and algorithm model runs. The objective will be to continuously add new and enhanced cash network designs and algorithm templates in each decision module, industry templates and data integrations to solve additional use cases based on user feedback and research.

### CROSS-REFERENCE TO RELATED APPLICATIONS

The present application is related to and claims priority of U.S. provisional patent application Ser. No. 63/351,417, entitled “INTEGRATED CASH NETWORK DECISION OPTIMIZATION PLATFORM,” filed on Jun. 12, 2022. The disclosure of these provisional patent applications is hereby incorporated by reference in their entireties.

### FIELD OF INVENTION

Various embodiments of the disclosure relate generally to cash optimization and techniques associated with optimization processing of several types of cash related decisions. More specifically, various embodiments of the disclosure relate to an integrated cash network decision optimization platform.

### BACKGROUND

Traditionally, any planner (such as an individual, or a financial advisor) develops a comprehensive financial plan that will aid them in achieving their financial goals. Traditionally, many planners have entrusted their financial plans to a specialist group of entities. More recently, these planners have increasingly relied upon computer-based systems that organize their financial assets and liabilities and further provide them with a summary of their financial health. However, these systems tend to focus on the administrative aspects of financial planning without enabling the user to make reasoned choices about their financial futures. Furthermore, these systems are limited by their inability to dynamically analyse the financial goals. These limitations are counterproductive to the user's needs to develop and manage an integrated financial plan from an executive decision-making perspective. Many existing financial management systems and tools allow users to electronically organize their financial assets and liabilities. These systems typically focus on presenting the user with a transactional summary of their financial health. However, these systems fail to capture the user's financial intentions and expectations about their future. Furthermore, these systems typically rely on the user to continually update their financial data. As a result, these systems are merely data-driven calculators that are incapable of providing the user with meaningful financial advice tailored to their financial intentions and expectations.

Similarly, some financial management systems present a static view of the user's financial health. These systems typically require the user to provide the most current financial data relating to their financial assets and liabilities. Consequently, when the user wishes to develop or update their financial plan, the user must input their most recent financial information. This problem is further exacerbated by the fact that these systems demand a lot of typing and guessing when the user enters their financial data. This process is time-consuming and inefficient and does not promote an intuitive understanding of how complex financial variables interact to produce a sensible financial plan. A true user-friendly system would have to include a simple and intuitive graphical user interface. A financial modelling is not very useful and accurate if the user does not submit all his financial data because it is tedious to input all that data. Another problem with many existing financial management systems is that the user is typically limited to managing the transactional details of their financial data. In these systems, the user is shielded from the planning and deciding aspects of developing their financial plan. Accordingly, the user learns very little from the process and remains heavily dependent on the system to provide an accurate summary of their financial health. These limitations further exacerbate the lack of trust inherent within the relationship between the user and the financial management system.

No system currently exists that dynamically incorporates all the user's financial assets and liabilities into an integrated summary of their health. Planners do not want to focus on the transactional details of their financial information. Instead, the planners desire to assume an executive decision-making role in managing their financial life. Thus, an integrated cash network decision optimization platform is needed where the user is provided with an integrated summary of their financial health and is given personalized financial advice using a recommendation engine tailored to their financial goals and intentions, and which also allows the user to manually analyse and correct the cash activity and cash value resources to initiate and take best possible actions.

### SUMMARY

In this section, we describe an integrated cash network decision optimization platform. The platform facilitates real time integrated cash and profit projections, budgeting, and forecasting using predictive, prescriptive, and cognitive (artificial intelligence) machine learning models combined with alert-based user decision planning process. The platform may also allow a user to apply unlimited what-if scenarios changing user assumptions, planned actions, and goals to evaluate impact. The platform converts cash related activity into a cash network to apply network optimization algorithms to maximize cash value and performance The platform provides users with the ability to build risk profiles and evaluate applicable external investments, financing, and operational products through integrated marketplace as part of scenario modelling and algorithm model runs. The objective will be to continuously add new and enhanced cash network designs and algorithm templates in each decision module, industry templates and data integrations to solve additional use cases based on user feedback and research. This common repository will continue to grow and will be available to all the eligible users. Another important goal of the platform is to ensure continuous evolution of AI (Artificial Intelligence) Decision Advisor to act as AI voice and chat assistant in the decision-making process and to provide real time strategy recommendations. The present invention deploys powerful analytics, machine learning, optimization, and artificial intelligence algorithms to diagnose performance trends, build predictions, prescribe recommendations, and set up automated processes.

The present invention discloses an integrated cash network decision optimization platform. The goal is to maximize value on investments and minimize cost of meeting targets. The user will be allowed to set-up investments, financing options, and restrictions. In addition, the user will also be allowed to evaluate algorithm outcomes and schedule automated runs. The real time integrated cash and profits projections, budgeting, and forecasting may be accordingly executed by using machine learning models. In brief, the platform may be utilized by a user to build cash and profit projections, take optimal decisions, and make action plans to maximize cash value (i.e., return on investment “ROI”) performance The key features include but are not limited to:

Decision Hierarchy: By building cash projection decision optimization hierarchy, decision-making modules for each level of hierarchy.

Projection Cash Network Designs: By building cash projection network at every level of projection hierarchy to define applicable line-item hierarchy, cash value attributes (product, services, resources, assets, or the like) to calculate cash activity, performance metric, and network action systems or stakeholders.

Predictive Algorithms: By having timeseries, heuristics, and machine learning forecasting algorithms to build baseline forecasts and projections for the line items.

What if Scenarios: By having ability to run impact analysis scenarios at various levels of projection and line-item hierarchy to evaluate various decision options and action plans. Scenarios from lower level of hierarchy can feed into higher level of hierarchy, and vice-versa.

Optimization Algorithms Templates: By designing network decision-making algorithm formulations using various objectives, decision choices, choice parameters, user constraints applying machine learning and mathematical optimization techniques such as linear programming, nonlinear programming, simulation, heuristics and so on to mathematically evaluate various decision options, action plans and constraints to recommend optimal solutions. By designing integration algorithms across decision hierarchy to create efficient frontiers (optimal decision options) to feed back and forth across projection hierarchy optimization algorithms.

Reconciliation and Integration Algorithms By designing reconciliation algorithms to match data across line item and projection hierarchy using top-down and bottom-up approach.

Thus, the objective of the present invention is to build a cash network projection integrated with user decision-planning process, for one or more types of entities such as, without limitation, an individual personal planner, or a business enterprise. Another objective includes accessibility of traditional as well as state of the art prebuilt applied and customizable financial, operational and lifestyle prescriptive decision formulations using algorithms at one place. Another objective includes reconciling decision-making modules from every level of hierarchy using algorithms and objectives enabling top-down as well as bottom-up approach. Another objective includes connecting every decision at every stage of hierarchy to applicable level of financial and operating performance metric to evaluate impact. Another objective includes integration of cash network decision optimization platform with existing planning and execution systems and processes to solve real-life problems and provide tangible benefits.

The present invention aims at providing efficient and effective solutions for cash projections, profit projections, budgeting, excess cash usage, revenue optimization, cash shortage avoidance, costs reductions, and so on. The disclosed solution provides a ready to implement one stop cash and profit optimization tool for all users. The disclosed solution further provides personalized targets, KPIs, and alerts monitoring with integrated user decision planning process, one click projections using advanced forecasting methods, unlimited what if scenarios to adjust projections, customizable prescriptive algorithms to recommend optimal decisions, comprehensive actions calendar and integrations, loans and investments marketplace to try financial products and value driven pricing with cost effective decision support team.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The invention is explained in further detail, and by way of example, with reference to the accompanying drawings wherein:

FIG. 1 shows a diagram that illustrates an overview of the proposed solution, in accordance with an exemplary embodiment of the disclosure. The proposed solution is implemented by means of an integrated cash network decision optimization platform.

FIGS. 2a and 2b are diagrams that illustrate usage and benefits of the proposed solution, in accordance with an exemplary embodiment of the disclosure.

FIG. 3 is a block diagram that illustrates a system environment in which various operations of the proposed solution are practiced, in accordance with an exemplary embodiment of the disclosure.

FIGS. 4a and 4b are diagrams that illustrate a decision algorithm data flow and an algorithm model run flow using a sample business problem, in accordance with an exemplary embodiment of the disclosure.

FIG. 5 is a block diagram that illustrates cash network design illustrations, in accordance with an exemplary embodiment of the disclosure.

FIG. 6 is a block diagram that illustrates a process to utilize the cash network algorithms in planning and decision, in accordance with an exemplary embodiment of the disclosure.

FIG. 7 is a block diagram that illustrates an automated process flow, in accordance with an exemplary embodiment of the disclosure.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment, or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in an embodiment” or “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. In addition, as used herein, the term “or” is an inclusive “or” operator and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” may include singular or plural references. The meaning of “in” includes “in” and “on.”

The following is a description of illustrative embodiments that when taken in conjunction with the following drawings will demonstrate the above noted features and advantages, as well as further ones. In the description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, tools, techniques, and methods are omitted so as not to obscure the description of the present system. It should be expressly understood that the drawings are included for illustrative purposes and do not represent the scope of the present system. In the accompanying drawings, like reference numbers in different drawings may designate similar elements.

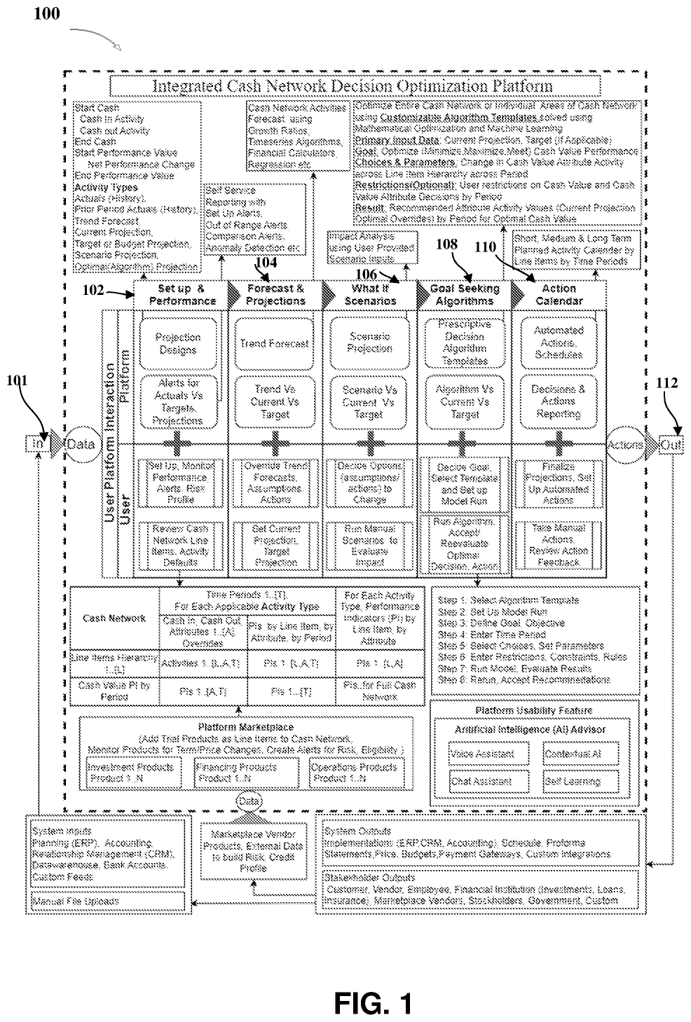

Referring to FIG. 1, there is shown a diagram 100 that illustrates an overview of the proposed solution, in accordance with an exemplary embodiment of the disclosure. The proposed solution is implemented by means of an integrated cash network decision optimization platform 100. The platform allows executives, analysts, and advisors combine business expertise with power of predictive, prescriptive, and cognitive algorithms to make informed decisions. The disclosed solution provides a ready to implement one stop cash and profit optimization tool for all users, personalized targets, KPIs, and alerts monitoring with integrated user decision planning process, one click projections using advanced forecasting methods, unlimited what if scenarios to adjust projections, customizable prescriptive algorithms to recommend optimal decisions, comprehensive actions calendar and integrations, loans and investments market place to try financial products, and value driven pricing with cost-effective decision support team. Benefits include optimize cash value, minimize costs, minimize financial risks, optimize pricing, maximize profit, maximize yield, and drive operational efficiency but should not be construed as limiting to the scope of the present invention.

As shown, the platform includes various sections such as a setup and performance section 102, a forecast and projection section 104, a what-if scenarios section 106, a goal seeking algorithm section 108, and an action calendar section 110.

In an embodiment, the platform receives the input data 101 from one or more input sources, either automatically from the assigned computing devices or manually as uploaded by one or more individual or enterprise entities. The input may include integration data systems such as planning (ERP—Enterprise Resource Planning), accounting data, relationship management (CRM—Customer Relationship Management), data warehouses, data lakes, bank accounts, custom feeds, financial accounts, or the like. In addition, the platform may facilitate to upload other or related files manually. The received data is then processed by the platform.

In the setup and performance section 102, the platform takes in the received data and feeds it into the cash network projection design templates. The platform further sets the performance indicators. The projection templates may include requisite domains such as start cash (including cash in, cash out, and net cash activity), end cash, start cash value (including cash value in, cash value out, net cash value), end cash value, start performance value (including net performance change), and end performance value. The platform sets the default trend forecast and base projections methods for various parts of cash network. The activity types may include actuals (history), prior period actuals (history) which is calculated to compare performance, trend forecast which is built using predictive forecast methods, current projection which is de facto master plan at any given point in time to manage and take actions, target or budget projection which is created periodically for setting and tracking goals, scenario projection which is estimated during what if scenario analysis, and optimal (algorithm) projection which is recommended by prescriptive algorithm model runs. In detail, there are several types of activities that can be used to track and manage performance, including:
1. Actuals (history): These are the actual results that have occurred in the past, such as sales revenue or expenses incurred. Actuals can be used to provide a benchmark for comparing current performance against historical performance Example: A company can compare their current month's sales revenue to the same month's sales revenue from the previous year to see if they are performing better or worse.
2. Prior period actuals (history): These are actual results from a previous period, such as last quarter or last year, that are used as a baseline for comparison. This type of activity can help identify trends in performance over time. Example: A company can compare their current quarter's revenue to the revenue from the same quarter in the previous year to identify any trends in revenue growth or decline.
3. Trend forecast: This is a projection of future performance based on historical data and statistical methods. Trend forecasts can be used to identify potential future trends in performance and help make informed decisions about resource allocation. Example: A company can use trend forecasting to project future sales revenue based on historical sales data and market trends.
4. Current projection: This is a projection of future performance based on current information and assumptions. Current projections can help organizations plan and make decisions in real-time. Example: A company can create a current projection of their expected revenue for the current quarter based on current market conditions and customer demand
5. Target or budget projection: This is a projection of future performance based on specific targets or goals. Target projections can be used to set performance expectations and track progress towards those goals. Example: A company can create a target projection of their expected revenue for the year based on their annual revenue target.
6. Scenario projection: This is a projection of future performance based on hypothetical scenarios, such as changes in market conditions or shifts in consumer behavior. Scenario projections can help organizations plan for potential changes in the future. Example: A company can create a scenario projection of their expected revenue if a major competitor enters the market and takes away market share.
7. Optimal (algorithm) projection: This is a projection of future performance based on mathematical models and algorithms Optimal projections can help identify the best course of action to take in order to achieve a desired outcome. Example: A company can use an optimal projection to determine the best pricing strategy for their products based on their desired profit margins and market conditions.

In the setup and performance section 102, the platform is configured to perform projection designs and generates alerts for actual vs planned target and projections. The platform is configured to generate self-service reporting with set up alerts, out of range alerts, comparison alerts, anomaly detection, etc. Further, a user (who interacts with the platform) may set up and monitor performance, alerts, and risk profiles. The user may further review cash network line items and activity defaults. The platform is designed to perform projection designs and generate alerts for actual versus planned target and projections. This means that the platform is able to predict what the outcome of a particular action or decision might be and generate alerts if the actual results differ from what was predicted. For example, a business might use this platform to predict how many sales they expect to make in a given month. If the actual sales fall short of this prediction, the platform would generate an alert to let the business know that they are not meeting their target. The platform is also designed to generate self-service reporting with set up alerts, out of range alerts, comparison alerts, anomaly detection, etc. Self-service reporting means that the user can personalize reports on their own without requiring assistance from the platform's administrators. Alerts can be set up to notify the user when certain conditions are met, such as when a particular metric falls outside of a certain range or when an anomaly is detected in the data. For example, a business might set up an alert to notify them when their website traffic falls below a certain threshold. This would allow the business to take action to try to increase their traffic before it becomes a major issue. Furthermore, a user who interacts with the platform may set up and monitor performance, alerts, and risk profiles. This means that the user is able to configure the platform to monitor the performance of various metrics, set up alerts for specific conditions, and track risk profiles. For example, a business might want to monitor their social media engagement to see if their posts are resonating with their audience. The user could set up the platform to track metrics such as likes, comments, and shares and receive alerts if engagement falls below a certain level. Finally, the user may review cash network line items and activity defaults. This means that the user is able to review the details of various financial transactions and check that they are in line with the activity defaults that have been set up within the platform. For example, a business might review their bank statements to ensure that all transactions have been properly recorded in the platform and that they are being categorized correctly. This would help the business to ensure that their financial reporting is accurate and up to date.

In the forecast and projection section 104, the platform is configured to generate trend forecast and provides ability to compare multiple trend forecasts built using different forecasting methodologies with current projection and target projection. For example, the platform may generate cash network activities forecast using growth ratios, timeseries algorithms, financial calculators, regression, etc. Further, the user may override the trend forecasts, assumptions, and actions to set up current projection. The user may further periodically set one of the current projections as a target projection or budget for performance and goal tracking. This section is configured to generate trend forecasts and provide the ability to compare multiple trend forecasts built using different forecasting methodologies with the current projection and target projection. This means that the platform can generate forecasts for various metrics, such as cash network activities, using different forecasting methodologies like growth ratios, timeseries algorithms, financial calculators, regression, etc. The platform can then compare these forecasts. The platform can compare trend forecasts generated by different methods to the current projection and target projection to help the user identify any discrepancies or changes that may need to be made. For example, a business might use the platform to generate a forecast for their sales revenue for the upcoming quarter. The platform might use various forecasting methodologies, such as growth ratios or regression analysis, to generate multiple forecasts. The user can then compare these forecasts with the current projection and target projection to see if any adjustments need to be made to their business plan. Furthermore, the user may override the trend forecasts, assumptions, and actions to set up the current projection. This means that the user is able to manually adjust the forecasts generated by the platform based on their own insights and knowledge of their business. For example, a business might override the forecast for their sales revenue if they know that a major competitor is entering the market in the upcoming quarter. They might adjust the forecast downwards to account for the increased competition. If user does not make any overrides, the default trend forecast would become baseline current projection. The user may also periodically set one of the current projections as a target projection or budget for performance and goal tracking. This means that the user can use the current projection at a start of period as a baseline for their business plan and track their performance against it. For example, a business might set the current projection for their sales revenue as the target projection for the upcoming quarter. They can then track their actual sales revenue against this target projection and adjust their business plan accordingly if they are not on track to meet their target. In summary, the forecast and projection section of the platform provides the user with the ability to generate forecasts for various metrics, compare different forecasting methodologies, manually adjust the forecasts, and periodically set the current projection as a target baseline for tracking performance and setting goals.

In the what-if scenarios section 106, the platform is configured to create a manual scenario projection by changing inputs and to compare against current projection and target projection. The scenario projections may be estimated to evaluate the projection impact using the user provided scenario inputs. Further, the user may decide to analyse various override options (assumptions, actions) by running multiple scenarios to evaluate impact for each option. In the what-if scenarios section 106, the platform is configured to create a manual scenario projection by changing inputs and to compare against the current projection and target projection. This means that the user can create “what-if” scenarios by changing the inputs used to generate the projections, and then compare these scenarios to the current projection and target projection. For example, a business might use the platform to create a scenario projection for their sales revenue for the upcoming quarter by changing the inputs that influence sales revenue, such as the price of their products or the size of their sales team. The platform would then generate a new projection based on these changed inputs, which the user can compare against the current projection and target projection. The scenario projections may be estimated to evaluate the projection impact using the user supplied scenario inputs. This means that the platform can estimate the impact of the user-provided scenario inputs on the projection. For example, if a business changes the price of their products in the scenario projection, the platform would estimate the impact of this change on the projected sales revenue. This helps the user understand the potential impact of their input changes on the projection. Furthermore, the user may decide to analyze various override options (assumptions, actions) by running multiple scenarios to evaluate the impact for each option. This means that the user can test different assumptions and actions by running multiple scenarios and comparing the results. For example, a business might want to analyze the impact of hiring additional salespeople on their projected sales revenue. They could create multiple scenarios where they change the number of salespeople hired and then compare the results to see which option would have the biggest impact. In summary, the what-if scenarios section of the platform allows the user to create manual scenario projections by changing inputs and compare them to the current projection and target projection. The platform estimates the impact of the scenario inputs on the projection, and the user can analyze different override options by running multiple scenarios. This allows the user to evaluate different potential scenarios and make informed decisions about their business plan.

Accordingly, at the goal seeking algorithm section 108, the platform is configured to run prescriptive decision algorithm templates. The goal is to optimize entire cash network or individual areas of cash network using customizable algorithm templates solved using mathematical optimization and machine learning. The primary input data may include the current projection and target projection if applicable. The goal is to optimize (i.e., minimize, maximize, and meet) cash value performance The choices and parameters may include change in cash value attribute activity across line-item hierarchy across period and the inputs to calculate resulting cash value for the choice. For example, in case of cash shortage a new loan may be a choice, loan interest rate may be the parameter which can be used to calculate the cash value of total interest paid by period if the loan is selected. The restrictions which are optional may include user restrictions on cash value and cash value attribute decisions by period. The result may include recommended attribute activity values for possible choices which would become current projection optimal overrides if accepted. During the process, the user may decide goal, select template, and set up model runs. Further, the user may run algorithms, accept or re-evaluate optimal decisions and actions.

The platform may select an appropriate algorithm from various algorithm templates to optimize the cash network. For example, in case of excess cash or budget, execution of the selected algorithm will maximize value on investment. However, in case of cash shortage, execution of the selected algorithm will minimize cost of meetings targets. The platform also allows the user to interfere during the entire process. For example, the user may be allowed to customize the products and evaluate and monitor current performance and alerts. The user may be further allowed to define or redefine cash network. For example, the user may define or update line-item hierarchy from lineitem-1, lineitem-2 and so on, cash in and cash out activities by listing various related attributes from attribute-1, attribute-2 and so on, override types and periods from period-1, period-2 and so on for various short, medium, and long-term planning horizons. The attributes can be a property, a dimension or a measure of the line item which can allow the platform to calculate the cash and cash value of the line item for the network. The user may further define performance indicators (PI) by listing various related PIs such as PI-1, PI-2, and so on.

The user may be further allowed to override the trend forecast and actions as previously set automatically by the platform. The user may be further allowed to set and change targets and budgets. For example, the user may set cash, profit, costs, and cash value targets or budgets according to the desired preferences. The user may determine cash, budget requirements, and run scenarios to analyze risks and actions. The user may determine cash network PI targets and objectives. The user may access the platform marketplace and choose one or more from investment products (such as product-1, product-2, and so on), financing products (such as product-1, product-2, and so on), operation products (such as product-1, product-2, and so on), and so on. In some scenarios, these data may be provided or override by the marketplace vendors. The user may be further allowed to setup investments, financing, operating options, and restrictions and evaluate algorithm outcomes and accordingly schedule runs to finalize projections and action plans. This may lead to improvement in future cash and cash value performance by ensuring better cash control and increase in ROI (return on investments) and reduction in cost. The platform may also consider historical cash or business performance as input to ensure better cash control, increase in ROI and reduction in cost. Accordingly, the platform will also allow a user to apply unlimited what-if scenarios applying user assumptions, planned actions, and goals to evaluate impact. The platform will empower a user to select algorithm templates and set up unlimited model runs with goal, time period, choices, constraints to evaluate and obtain optimal recommendations. The objective will be to continuously add new and enhanced cash network designs and algorithm templates in each decision hierarchy module, industry specific templates and data integrations to solve additional use cases based on user feedback and research. This common repository will continue to grow and will be available to all the eligible users. Another important goal of the platform is to ensure continuous evolve of AI Decision Advisor to act as AI voice and chat assistant using large language models (LLMs) in the decision-making process and to provide real time strategy recommendations.

Further, at the action calendar section 110, the platform is configured to generate automated actions and schedules along with decision and action reports. The platform generates short, medium, and long term planned activity calendar by line items by time periods. The time period can be real-time, hourly, daily, weekly, monthly, quarterly, yearly, and so on. The user may finalize the projections, set up automated actions, take manual actions, and review action feedback. In addition, as shown at 112, the platform may output various projection outputs such as planned inventory, price changes, schedules into ERP (Enterprise Resource Planning), CRM (Customer Relationship Management), Accounting systems, build proforma statements and budgets, take actions through payment gateways and custom integrations. The platform may notify and connect with stakeholders, customers, vendors, employees, financial institution, and the like according to the applicability of the platform in real or near real time. As described above, the platform is designed to generate automated actions and schedules with decision and action reports. The platform creates a planned activity calendar with short, medium, and long-term schedules by line items and time periods, which can be in real-time, or any other period as required. For example, a business might use the platform to generate an automated schedule for purchasing inventory based on the projected sales revenue for the upcoming quarter. The user can also finalize projections, set up automated actions, take manual actions, and review feedback. Additionally, at 112, the platform may output various projection outputs such as planned inventory, price changes, and schedules into other business systems such as ERP, CRM, Accounting, and build proforma statements and budgets. The platform may also take actions through payment gateways and custom integrations and notify and connect with stakeholders, customers, vendors, employees, and financial institutions in real-time or near real-time as applicable. Overall, the action calendar section enables businesses to automate their operations, streamline decision-making, and improve communication with relevant parties.

In summary, the cash network platform has been built using cash network projection designs which include line-item hierarchy, attributes, activities, time periods, and performance indicators. Further, the cash network decisions are optimized using integrated goal seeking prescriptive algorithms for individual part of cash network as well as across entire cash network. The decision and action planning process or workflow has been integrated to provide descriptive, diagnostic, predictive, automation or cognitive services along with prescriptive algorithms for the cash network. This projection building and optimization process uses combination of self-service reporting, alerts, actuals, prior period actuals, trend forecast, overrides, current projection, target projection, scenario projection, optimal or algorithm projection, action calendar. Further, the self-learning AI assistant has been integrated to run the entire process using voice and chat. The external marketplace has been integrated to the decision making for financial and operating products to evaluate and monitor relevant products inside cash network before and after purchasing them. The platform features may be utilized to perform one stop tactical and strategic cash, profit, enterprise value projection optimizations using cash value to improve yield across Enterprise Cash Network Hierarchy aka enterprise resource optimization:
a) by either using customizable prebuilt projection networks and prescriptive algorithm business formulations for cash flow, account receivable, accounts payable, investments or assets, loans or liabilities, profit & loss, sales, costs (COGS), expenses, marketing expense, workforce expense, inventory,
b) or by building new cash networks with algorithms across businesses and industries

Further, these platform features may be utilized to perform one stop tactical and strategic cash, profit, net worth projection optimizations using cash value to improve yield across Personal Cash Network Hierarchy aka personal resource optimization:
a) by either using customizable prebuilt projection networks and prescriptive algorithms formulations for cash flow, account receivable (money lent), accounts payable (money owed), investments or assets, loans or liabilities, profit & loss, employment income, costs, recreation expense, shopping expense, health expenses,
b) or by building new cash networks with algorithms across personal lifestyle and wealth creation processes.

The platform has been built and designed to perform self-service reporting with one or more set up alerts, out of range alerts, comparison alerts, anomaly detection, or the like, or any combination thereof. The platform has been further built and designed to perform cash network activity forecasting using growth ratios, timeseries algorithms, financial calculators, regression, or the like, or any combination thereof. The platform has been further built and designed to perform impact analysis using user provided scenario inputs. The platform has been further built and designed to optimize entire cash network or individual areas of cash network using customizable algorithm templates solved using mathematical optimization and machine learning. Primary input data include current projection and target. Goal is to optimize (minimize, maximize, meet) cash value performance. Choices and parameters include change in cash value attribute activity across line-item hierarchy across period. Restrictions may include user restrictions on cash value and cash value attribute decisions by period. Result may include recommended attribute activity values by period for optimal cash value.

The optimization system described is a cash network optimization platform that has been built using cash network designs which include line-item hierarchy, attributes, activities, time periods, performance indicators, and override types. It is capable of receiving input data, processing it, and optimizing cash network decisions using integrated goal-seeking prescriptive algorithms across the entire cash network or individual parts. The platform is also capable of providing descriptive, diagnostic, predictive, automation, and cognitive services using self-service reporting, alerts, actuals, prior period actuals, trend forecast, overrides, current projection, target or budget projection, scenario projection, algorithm or optimal projection, and action calendar. The platform includes a self-learning and contextual AI assistant that runs the entire projection and decision planning process using voice and chat. The platform also allows for the integration of an external marketplace to decision making for financial and operating products to evaluate and monitor relevant products inside the cash network before and after purchasing them. Features of the platform include cash decision optimization algorithms templates, reconciliation of cash decisions, integrating cash projections design, scenarios, cash value algorithms, and cash value performance process, and planning and execution system integrations. The platform also allows users to customize products and evaluate and monitor current performance and alerts and to set sales, costs, and cash targets. It further allows users to override trend forecasts and actions as previously set and to set cash, income, costs, and cash value targets according to desired preferences. Examples of the platform's capabilities include performing self-service reporting with one or more set up alerts, out of range alerts, comparison alerts, and anomaly detection and performing cash network activity forecasting using growth ratios, timeseries algorithms, financial calculators, and regression. The platform is also capable of optimizing the entire cash network or individual areas of cash network using customizable algorithm templates solved using mathematical optimization and machine learning. The platform is designed to receive input data either automatically from assigned computing devices or manually as uploaded by one or more individual or enterprise entities.

The cash network optimization platform described in the given text has several advantages. Firstly, it is designed using line item hierarchy, attributes, activities, time periods, performance indicators, and override types, which makes it easy to organize and process input data for making cash network decisions. Secondly, the platform is optimized using integrated goal seeking prescriptive algorithms for individual parts of the cash network as well as the entire network, which helps in making accurate and efficient decisions. Thirdly, the platform provides self-service reporting, alerts, actuals, prior period actuals, trend forecast, overrides, current projection, target or budget projection, scenario projection, algorithm or optimal projection, and action calendar, which helps user to go through entire decision planning and execution process using descriptive, diagnostic, predictive, prescriptive, automation, and cognitive services at a single place. Fourthly, the platform includes a self-learning and contextual AI assistant that can run the entire projection and decision planning process using voice and chat. Additionally, the platform integrates an external marketplace to decision making for financial and operating products to evaluate and monitor relevant products inside the cash network before and after purchasing them. It also allows for self-service reporting with alerts and anomaly detection, and performs cash network activity forecasting using growth ratios, time series algorithms, financial calculators, and regression. The platform further allows for customization of products and the evaluation and monitoring of current performance and alerts. The user can also set sales, costs, and cash targets and override trend forecasts and actions as previously set. In summary, the advantages of the cash network optimization platform include its efficient organization and processing of input data, accurate and efficient decision-making through prescriptive algorithms, self-service reporting and analysis, AI (artificial intelligence) assistance, external marketplace integration, and the ability to customize products and set targets.

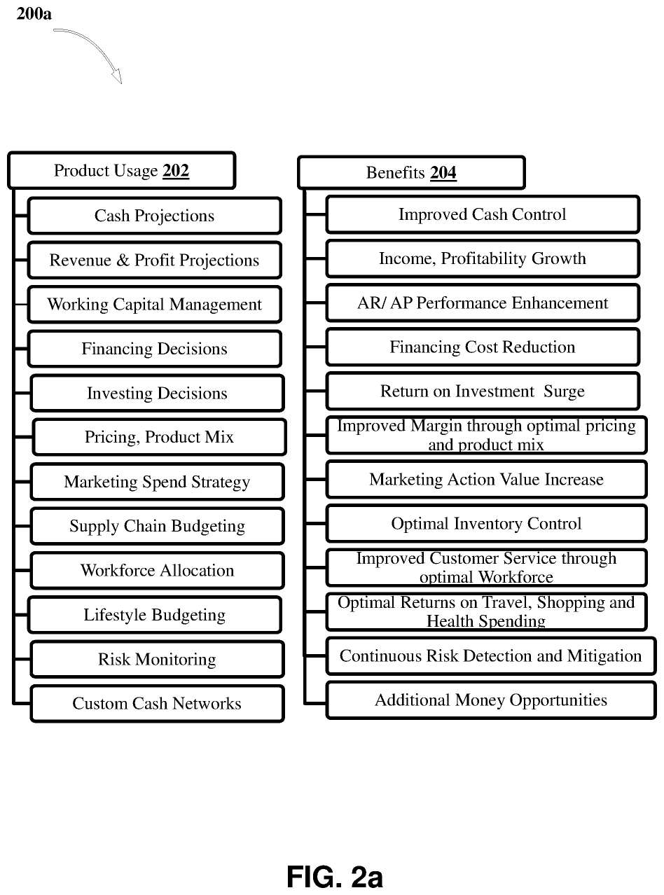

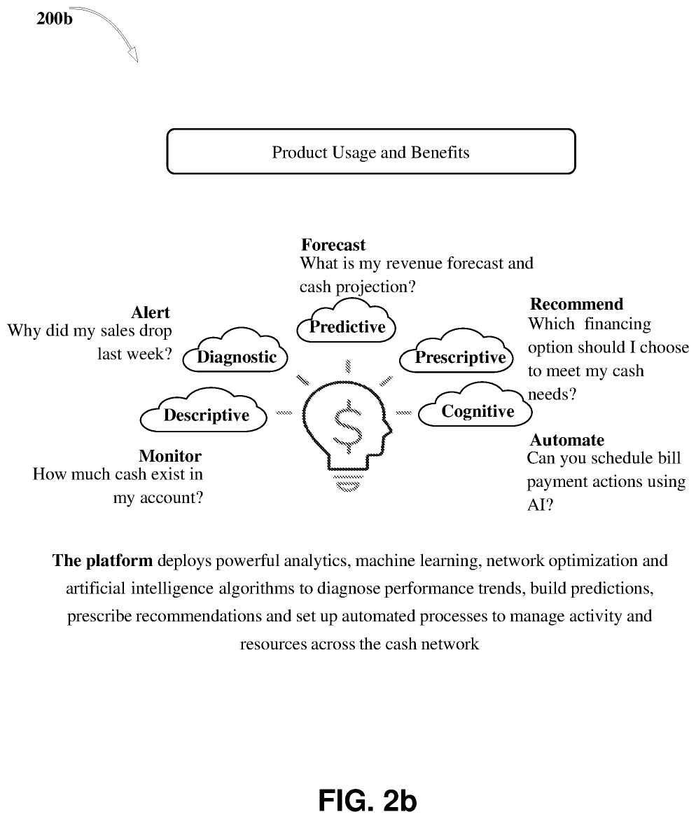

FIGS. 2a and 2b are diagrams 200a and 200b that illustrate usage and benefits of the proposed solution, in accordance with an exemplary embodiment of the disclosure. In an exemplary embodiment, the product usage 202 may include one or more of, but without any limitations, cash projections, revenue, and profit projections, working capital management, financing decisions, investing decisions, pricing and product mixing, marketing spend strategy, supply chain budgeting, workforce allocation, lifestyle budgeting, risk monitoring, and custom cash networks. In an exemplary embodiment, the product benefits 204 may include one or more of, but without any limitations, improved cash control, income growth, AR or AP performance enhancement, financing cost reduction, return on investment surge, improved margin through optimal pricing and product mix, marketing action value increase, optimal inventory control, improved customer service through optimal workforce, optimal returns on travel, shopping, and health spending, continuous risk detection and mitigation, and additional money opportunities. The present invention deploys powerful analytics, machine learning, network optimization, and artificial intelligence algorithms to diagnose the performance trends, build predictions, prescribe recommendations, and set up automated processes to manage activity and resources across the cash network. For example, the platform may be able to predict or forecast what will happen to cash balance if a user changes by revenue projections or what is my revenue forecast and cash projection. The platform may be able to recommend one or more price bands that can be offered on one or more products to increase sales. The platform may be able to recommend which financing option should I choose to meet my cash needs. The platform may be able to notify via an email or SMS when the cash goes below a prescribed limit such as $500. The platform may be able to further notify the total cash that is currently existing the user's account. The platform may be able to generate alerts such as why did my sales drop last week. The platform may be able to monitor how much cash exist in my account. The platform may be able to analyze the portfolio with all the input parameters and predict one or more reasons for any sales drop that may have occurred in a previous timeline such as the last week. The platform may be able to further automate bill payment actions using AI. The platform may be further configured to perform decision hierarchy by building decision optimization hierarchy, decision-making modules. The platform may be further configured to perform projection forecasting by building cash projection network at every level of hierarchy to define applicable cash activity line items, cash value activity (product or services) line items, performance metric, and network action nodes or stakeholders. The platform may be further configured to execute the predictive algorithms by having timeseries and machine learning forecasting algorithms to build baseline projections for the activities. The platform may be further configured to run impact analysis and scenarios at various levels of hierarchy to evaluate various decision options and action plans. Scenarios from lower level of hierarchy can feed into higher level of hierarchy, and vice-versa. The platform may be further configured to execute the optimization algorithms by designing network decision-making algorithm to mathematically evaluate various decision options, action plans and constraints to recommend optimal solutions. The platform many be further configured by designing integration algorithms across decision hierarchy to create efficient frontiers (optimal decision options) to feed back and forth across modules and hierarchy optimization algorithms The platform may be further configured to execute reconciliation and integration algorithms by designing reconciliation algorithms to match data across hierarchy and modules using top-down and bottom-up approach.

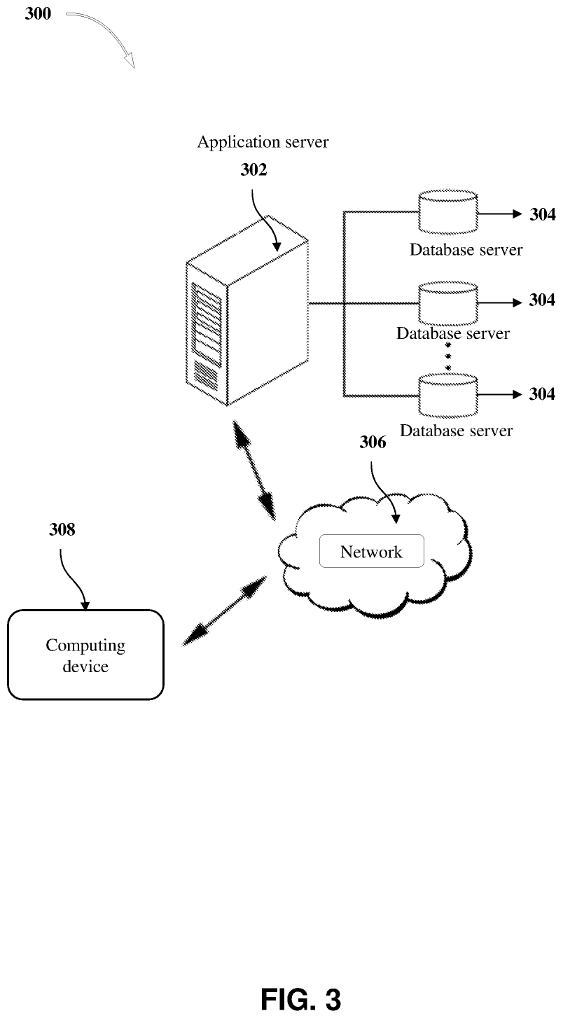

FIG. 3 is a block diagram 300 that illustrates a system environment in which various operations of the proposed solution are practiced, in accordance with an exemplary embodiment of the disclosure. The system environment 300 includes one or more computing servers such as an application server 302, one or more database servers such as a database server 304, and one or more networks such as a network 306. The system environment 300 further includes one or more user computing devices associated with one or more users such as a user computing device 308 associated with a user. Examples of the user computing device 308 may include a smartphone, a tablet computer, a laptop, or any other portable communication device. The application server 302 and the user computing device 308 may communicate with each other over a communication network such as the network 306. The application server 302 and the database server 304 may also communicate with each other over the same network 306 or a different network.

The application server 302 is a computing device, a software framework, or a combination thereof, that may provide a generalized approach to create the application server implementation. The application server 302 may include one or more processors, memory, transceivers, controllers, and communication interfaces for realizing its implementation. Examples of the application server 302 include, but are not limited to, a personal computer, a laptop, or a network of computer systems. The application server 302 may be realized through various web-based technologies such as, but not limited to, a Java web-framework, a .NET framework, a PHP (Hypertext Pre-processor) framework, or any other web-application framework. The application server 302 may also use Django (python framework), uses python machine learning libraries, Apache web server, Postgres database and Angular web framework for GUI. The application server 302 may operate on one or more operating systems such as Windows, Android, Unix, Ubuntu, Mac OS, or the like. Various operations of the application server 302 may be dedicated to execution of procedures, such as, but are not limited to, programs, routines, or scripts stored in one or more memory units for supporting its applied applications and performing one or more operations.

In an embodiment, the application server 302 may be configured to facilitate the platform for integrated cash network optimization. The application server 302 may be configured to facilitate real time integrated cash and profit projections, budgeting, and forecasting using machine learning models. The application server 302 may be configured to allow the user to apply unlimited what-if scenarios applying user assumptions, planned actions, and goals to evaluate impact. Another important goal of the application server is to ensure continuous evolve of AI Decision Advisor to act as AI voice and chat assistant in the decision-making process and to provide real time strategy recommendations. The application server 302 may be configured to execute resource optimization algorithms and deploys powerful analytics, machine learning, optimization, and artificial intelligence algorithms to diagnose performance trends, build predictions, prescribe recommendations, and set up automated processes.

In an embodiment, the application server 302 may be configured to perform data integration. This may be achieved by integrating the platform with planning and execution systems and processes to solve real-life problems and to provide tangible benefits. The application server 302 may be configured to perform customization of the platform. This may be achieved by providing the user ability to design custom modules with custom cash projection network including cash activity, cash value activity, performance indicators, action nodes or stakeholders, setting up algorithm schedules, default action plans, cash value performance monitoring alerts and parameters. The application server 302 may be configured to facilitate user control and flexibility on decision making This may be achieved by enabling the user to input assumptions, overrides and accept, run what if scenarios using customizable templates to make decisions and create inputs for optimization, constrain the optimization recommendations at every stage of data. The application server 302 may be configured to facilitate a marketplace for investment, financing, and operations cash value (products or services) options to try out into the decision-making process and algorithms before purchasing them. The application server 302 may be configured to facilitate AI decision assistant by developing AI strategy advisor and training assistant to navigate through the decision-making process.

In an embodiment, the application server 302 may be configured to formulate Cash Network Decision Optimization Algorithms across Decision Modules. This may include:

### Algorithm Objective

Maximizing performance of cash network by optimally allocating and deallocating cash and/or cash value across network
   Alternate Partial Objectives
   Maximize ROI on Excess Cash or Cash value while maintaining required cash or cash value and working capital to run operations
   Minimize Cost of Maintaining Required Cash or cash value and Working Capital for Cash or Cash value Shortage
   Maximize Performance of Budgeted (Fixed) Cash or Cash value

### Decisions Options

Excess Cash or Cash value
   Invest in operations to grow or improve operating value (Profit Module)
   Invest in financial liquid assets to earn non-operational income or purchase new assets (Investments Module)
   Pay back dividend to stockholders (Equity or Investment Module)
   Pay back principal amount on financing, Reduce Debt costs (Loans Module)
Cash or Cash value Shortage
   Borrow money from creditors using line of credit, factoring, merchant cash advance, other asset-based lending (Loans Module)
   Delay payments on current liabilities (Loans or AP Module)
   Sell assets including inventory (Investments or Inventory Module)
   Increase future operating cash (Revenue—Operating Costs) (Profit Module)
   Stock offering (Equity or Loans Module)
   Reject Cash or Cash value demand (Sales or Profit Module)

### Decision Restrictions or Constraints

User specified restrictions or constraint for various decision options.

The platform features include:
1. Cash Network Designs: Built-in customizable cash and cash value projections with projection hierarchy, line-item hierarchy, attributes, performance indicators, override types with planning goals.
2. Cash Decision Optimization Algorithms Templates: Built-in customizable business formulations using algorithms for each level of decision hierarchy.
3. Reconciliation of Cash Decisions: Connect decision algorithms and decisions at various levels of hierarchy with both bottom up and top-down approach.
4. Integrating Cash Projections Design, Scenarios, Cash value Algorithms, and Cash value Performance process.
5. Planning and Execution System Integrations: Integrate with Accounting, ERP, CRM, data warehouse financial accounts, and production applications using custom built data connectors and file transfers to send decisions and receive data.
6. Artificial Intelligence (AI) Assistant: Work with AI assistant to navigate through the process.
7. Utility: User Interface and Customization.

The platform offers a range of features that make cash decision optimization more efficient and effective. One key feature is the cash decision optimization algorithms templates which provide customizable business formulations for each level of decision hierarchy. For instance, a business may use these templates to create an algorithm for optimizing inventory purchases based on projected sales revenue. Another feature is the reconciliation of cash decisions, which allows for the integration of decision algorithms and decisions at various levels of hierarchy using both bottom-up and top-down approaches. This ensures that all decisions align with overall business goals. The platform also integrates cash projections design, scenarios, cash value algorithms, and cash value performance processes to streamline cash management. It can also integrate with accounting, ERP, CRM, and production applications using custom-built data connectors and file transfers to send decisions and receive data. The AI assistant feature helps users navigate the process of using the platform more effectively. Finally, the platform offers a user-friendly interface and customization options, making it easy for businesses to tailor it to their specific needs. Overall, these features help businesses optimize their cash decisions, improve efficiency, and align decisions with overall business goals.

The decision algorithm data flow include: (1) define business problem, cash network and decisions variables, followed by (2) get historical and current data from enterprise planning and execution applications, (3) create algorithm inputs using predictive methods and user insights, (4) search and select predefined business formulation using algorithms, (5) define objective, (6) define constraints, (7) run algorithm, (8) review results and recommendations, (9) redefine inputs and constraints, (10) rerun the algorithm, (11) compare multiple runs and scenarios, (12) accept and override recommended decisions, (13) schedule the algorithm runs, (14) integrate multiple algorithms, and (15) send recommended decisions, actions to planning and execution.

The database server 304 may include suitable logic, circuitry, interfaces, and/or code, executable by the circuitry that may be configured to perform one or more data management and storage operations such as receiving, storing, processing, and transmitting queries, data, content, algorithms, code, or the like. In an embodiment, the database server 304 may be a data management and storage computing device that is communicatively coupled to the application server 302 or the user computing device 308 via the network 306 to perform the one or more operations. In an exemplary embodiment, the database server 304 may be configured to manage and store one or more profiles of the one or more users. Each profile may include information such as a user's name, number, email, preferences, cash flow, investment profiles, or the like. In an exemplary embodiment, the database server 304 may be further configured to manage and store one or more algorithms, rules, code, or the like that are retrieved and executed by the application server 302 to perform the one or more designated operations in the real time. In an exemplary embodiment, the database server 304 may be further configured to manage and store one or more notifications. In an embodiment, the database server 304 may be further configured to receive a query from the application server 302 for retrieval of the stored information. Based on the received query, the database server 304 may communicate the requested information to the application server 302. The database server 304 may be implemented by means of a personal computer, a laptop, or a network of computer systems. Examples of the database server 304 may include, but are not limited to, MongoDB, Cassandra, and HBase, or Structured Query Language (SQL) database.

The network 306 may include suitable logic, circuitry, interfaces, and/or code, executable by the circuitry that may be configured to transmit messages and requests between various entities, such as the application server 302, the database server 304, and the user computing device 308. Examples of the network 306 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 300 may connect to the network 306 in accordance with various wired and wireless communication protocols, such as Transmission Control Protocol and Internet Protocol (TCP or IP), User Datagram Protocol (UDP), Long Term Evolution (LTE) communication protocols, or any combination thereof.

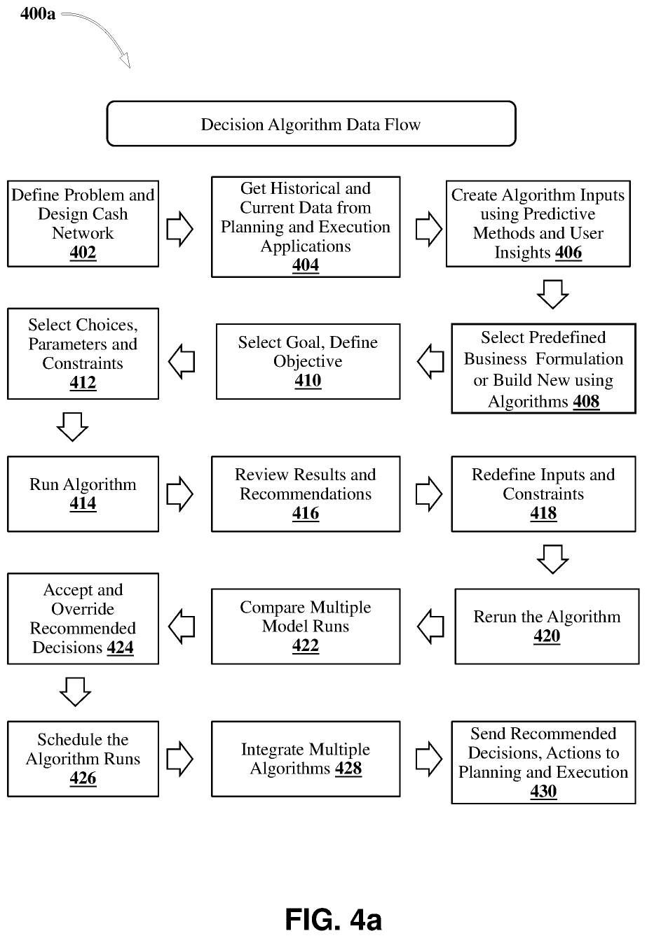

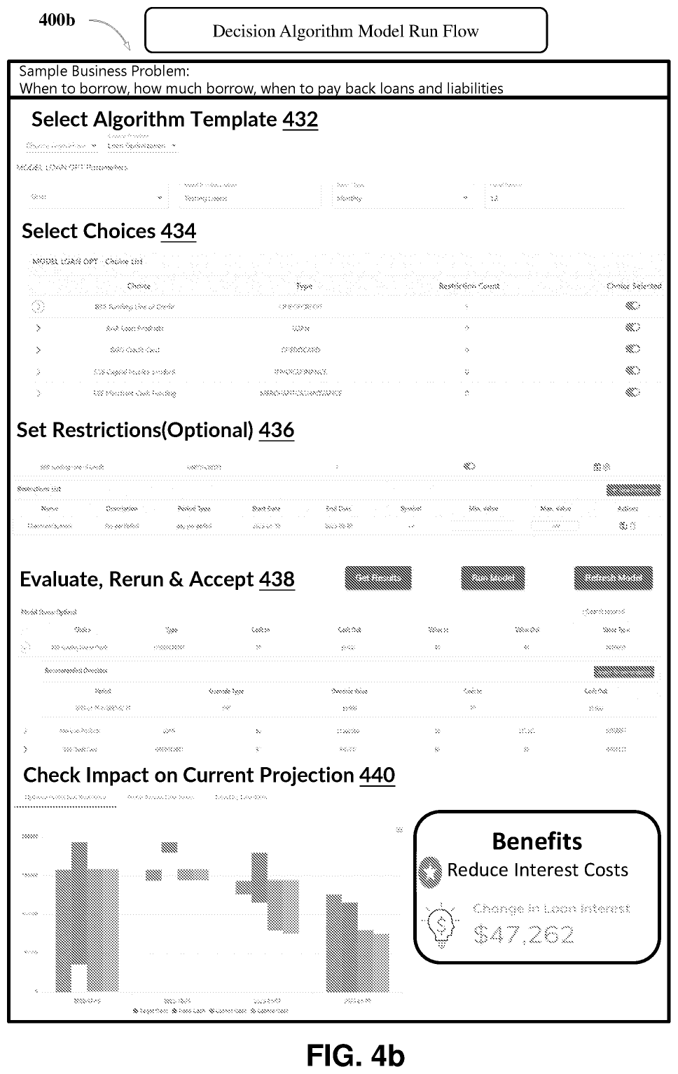

FIG. 4a is a block diagram that illustrates a decision algorithm data flow 400a, in accordance with an exemplary embodiment of the disclosure. At 402, business problems and decisions variables are defined, and cash network is designed. In an embodiment, the application server 302 may be configured to define the business problems and decisions variables and design the cash network based on input provided by a user. At 404, historical and current data are obtained. In an embodiment, the application server 302 may be configured to get the historical and current data from planning and execution applications. At 406, algorithm inputs are created. In an embodiment, the application server 302 may be configured to create the algorithm inputs using the predictive methods and user insights. At 408, predefined business formulation is selected. In an embodiment, the application server 302 may be configured to search and select the predefined business formulation or build new ones using the algorithms. At 410, one or more goals are selected, and one or more objectives are defined. In an embodiment, the application server 302 may be configured to selects the goals and define the objectives. At 412, one or more choices, parameters, and constraints are selected. In an embodiment, the application server 302 may be configured to select the one or more choices, parameters, and constraints. At 414, one or more algorithms are run. In an embodiment, the application server 302 may be configured to run the one or more algorithms The algorithm theory may include but are not limited to financial planning models, heuristics, linear, integer, mixed integer programming, nonlinear, stochastic programming, simulation, Markov chain, timeseries, regression, clustering, classification, machine learning, artificial intelligence, custom designs, and the like. At 416, one or more results and recommendations are reviewed. In an embodiment, the application server 302 may be configured to review the one or more results and recommendations. At 418, the one or more inputs and constraints are redefined. In an embodiment, the application server 302 may be configured to redefine the one or more inputs and constraints. At 420, the one or more algorithms are rerun. In an embodiment, the application server 302 may be configured to rerun the one or more algorithms At 422, the multiple model runs and scenarios are compared. In an embodiment, the application server 302 may be configured to compare the multiple runs and scenarios to fine tune the outcome as per the desired characteristics. At 424, the recommended decisions are accepted and overridden. In an embodiment, the application server 302 may be configured to accept and override the recommended decisions. At 426, the algorithm runs are scheduled. In an embodiment, the application server 302 may be configured to schedule the algorithm runs. At 428, multiple algorithms are integrated. At 430, the recommended decisions and actions are sent. In an embodiment, the application server 302 may be configured to send the recommended decisions and actions to the planning and execution applications. The present invention aims at providing efficient and effective solutions for cash projections, profit projections, excess cash usage, revenue optimization, cash shortage avoidance, costs reductions, and so on.

### Problem: How to Optimize All Cashflow Decisions Simultaneously?

### Solution:

Algorithm Goal
Maximizing yield on cash by allocating and deallocating cash and cash equivalents across cash network
   Alternate Goals:
   Maximize ROI on excess cash while maintaining required cash and working capital
   Minimize cost of maintaining required cash and working capital for cash shortage
   Maximize yield of budgeted cash spend
   Meet revenue target while maximizing yield on cash

Choices and Restrictions for AR, AP, Loans, Investments, Profit and Loss, Equity

Recommended Actions
While Excess Cash or Cash Budget
   Invest in future operations to grow or improve operating value (Expenses)
   Invest in financial liquid assets to earn non-operational income or purchase new assets (Investments)
   Pay back principal amount on financing, Reduce Debt costs (Loans)
   Pay back dividend to stockholders (Equity)
While Cash Shortage
   Borrow money from creditors using line of credit, factoring, merchant cash advance, other asset-based lending, etc. (Loans)
   Collect money faster from customers by providing discounts or through invoice financing (AR)
   Delay payments on current or future liabilities—COGS, expenses, loan (AP)
   Sell assets (Investments)
   Increase future operating cash (Revenue—COGS—Expenses) (Profit & Loss)
   Stock offering (Equity)
      Benefits: Always optimal and maximize cash value

### Problem: When to Borrow, How Much Borrow, When to Pay Back Loans and Liabilities?

### Solutions:

Define goal and set up minimize liabilities and interest costs

Select choices:
1) Existing balance sheet loans and liabilities with fees, interest, terms parameters
2) New or future loans line items with fees, interest, terms parameters
3) Lock all other cash flow projection activity
   Enter restrictions (optional):
1) Minimum cash on hand to maintain per period, starting cash
2) Maximum willingness to borrow or pay by time period by loan line item
3) Maximum interest to pay by time periods by loan line item
4) Lock pay or borrow actions by time period by loan line item
5) Total loan or liability limit per period
   Run algorithm:
1) Recommended pay or borrow actions by time period by selected choice
2) Optimal total value (costs or savings) to meet the goal
   Benefits: Always optimal and reduce costs

### Problem: When to Invest, Where to Invest and How Much to Invest?

### Solutions:

Define goal & set up minimize liabilities and interest costs

Select choices:
1) Existing balance sheet investments and CDs
2) New or future investments interest rates, terms, etc.
3) Lock all other cash flow projection activity
   Enter restrictions (optional):
1) Minimum cash on hand to maintain per period, starting cash
2) Maximum willingness to invest or withdraw by time period by investment line item
3) Lock invest or withdraw actions by time period by investment line item
4) Total investment limit per period
   Run algorithm:
1) Recommended invest or withdraw actions by time period by selected choice
2) Optimal total value (interest income) to meet the goal
   Benefits: Always optimal and increase investment interest

### Problem: When to Pay Bills, Which One to Pay?

### Solutions:

Define goal and set up minimize total payables, maximize cash flow, optimize cashflow

Select choices:
1) Bills, vendors, and vendor segments
2) Advance payment discount rate
3) Lock all other cash flow projection activity
   Enter restrictions (optional):
1) Minimum cash on hand to maintain per period, starting cash
2) Maximum delay allowed for bill, vendor, or vendor segment
   Run algorithm:
1) Recommended payment period for each bill
2) Total savings from advance payment discount
   Benefits: Always optimal and automate bill payments

### Problem: How Much Expense is Possible Given Current Cash and Profit Targets?

### Solutions:

Define goal and set up: expense reduction to meet cash needs

Select choices:
1) Expenses
2) Lock all other cash flow and profit projection activity
   Enter restrictions (optional):
1) Maximum or minimum limit for each expense account per period or over multiple periods.
2) Maximum or minimum limit for total expenses per period or over multiple periods.
   Run algorithm:
1) Recommended reduction if needed
   Benefits: Always optimal, right expense reduction, reduce cash needs

### Problem: How Much to Sell Given Cogs Needs and Projected Cash or Budget Availability?

### Solutions:

Define goal and set up minimum change in sales, cogs rate, price, quantity to fulfil cash needs, maximize gross and net profit margin for pricing, minimize holding costs.

Select choices:
1) Sales, cogs, price, quantity, expenses
2) Lock all other cash flow and profit projection activity
   Enter restrictions (optional):
1) Maximum or minimum limit for each account per period or over multiple periods
2) Maximum or minimum limit for total sales per period or over multiple periods
3) Maximum or minimum limit for price changes per period or over multiple periods
4) Maximum or minimum limit for inventory changes per period or over multiple periods
   Run algorithm:
1) Recommended change across quantity, pricing, inventory, expenses if needed
   Benefits: Always optimal, determine right amount of sales or cogs feasible with current cash projection, optimal sales quantity, pricing, inventory, and expense allocation

FIG. 4b is a wireframe diagram 400b that illustrates algorithm model run flow using an example Problem stated ‘when to borrow, how much to borrow, when to pay back loans and liabilities’ using sample data, in accordance with an exemplary embodiment of the disclosure. The algorithm model run flow illustrates how a user can utilize the platform to set up and evaluate an algorithm model run. At 432, a user can select an algorithm template such as Loan Optimization, and set the model run parameter including goal, description, period type such as monthly, weekly, daily, quarterly and number of periods. Once an algorithm template is selected, the platform will populate all the eligible choices for the selected algorithm at 434. The user can select the choices that need to be considered for the model run. In the loan optimization illustration, all the available choices (loan products) are selected for the algorithm to evaluate. Further, the user can change parameters for each choice such as terms and/or interest rates in case of a loan product. At 436, the user can add restrictions that the algorithm must consider in the recommendations. The restrictions can be set at individual choice level such as constraining maximum allowed payment in a period. For example, for the choice, BBB Funding Line of Credit, the maximum allowed payment per period from date Jan. 10, 2023, to date Feb. 28, 2023, is $5000. Further, the user can set up global restrictions or any other non-choice related restrictions allowed by the algorithm template. For example, in case of the loan optimization, the global restriction might be maintaining a certain amount of starting cash while optimizing loans. At 438, the user has multiple options, (a) to run the new model to get results, or (b) to directly get results if the model was previously run manually or by a scheduled process, or (c) to refresh the model input data if any input data points in the current projection are changed since the last time the model was run and then rerun the model. The platform shows the results and optimal model recommendations (overrides) for various choices by time period along with cash in, cash out, value in, value out, and value type fields to facilitate user review of the recommendation. For example, the model recommended to pay $5000 in period between Jan. 6, 2023 and Feb. 2, 2023 for the loan product BBB Funding Line of Credit. The user can further compare performance indicators and line items across various activity types of trend, current, target and optimal (model) as illustrated in the chart, as well as review the benefits of the recommendations to make informed decision at 440. For example, for the illustrated loan optimization example, given all the inputs, the user would save estimated $47,262 in interest cost if all the model recommendations are accepted in the current projection. After evaluations, reruns, review, the user can accept the recommendations one by one or accept all of them at 438.

In summary, the optimization system allows a user to select and customize algorithm templates for loan optimization, set model run parameters, select eligible choices, add restrictions, and review optimal model recommendations for various choices by time period. The system further enables the user to compare performance indicators and line items across various activity types of trend, current, target and optimal (model), as well as review the benefits of the recommendations to make informed decisions. An important advantage of this optimization system is that it provides a comprehensive and user-friendly interface for selecting and customizing algorithm templates and running optimization models, allowing users to easily explore different scenarios and evaluate the impact of potential changes. The system also supports various input data points and provides optimal recommendations for multiple choices and time periods, helping users to make more informed and data-driven decisions. Another advantage is the ability to set restrictions, which can ensure that recommendations align with user-specified constraints and limitations. Overall, the optimization system can help users to streamline their decision-making processes, optimize their cash network performance, and potentially achieve significant cost savings or other benefits.

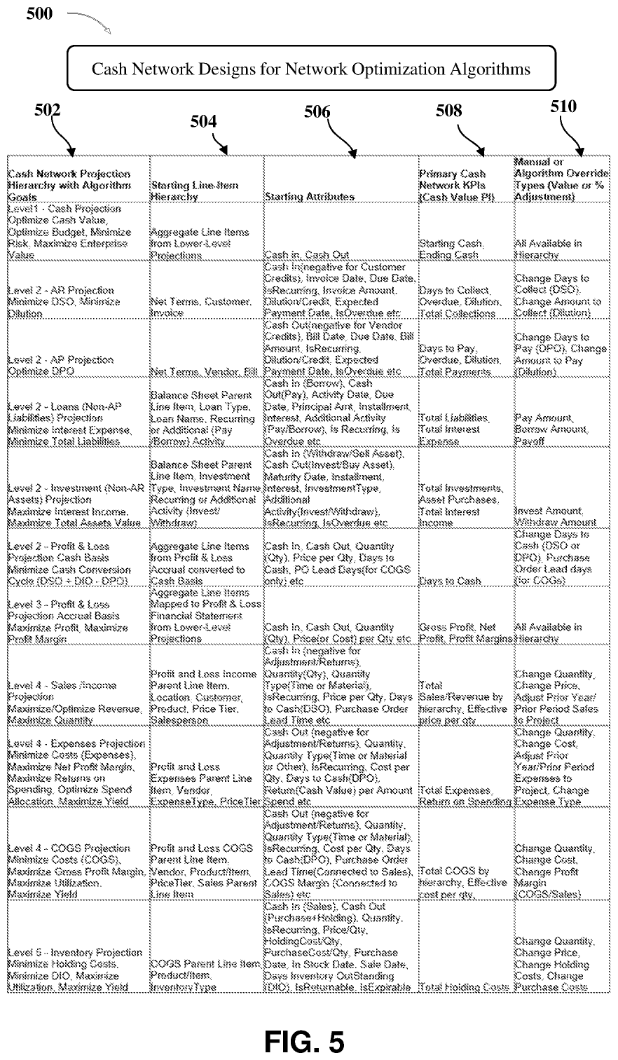

FIG. 5 is a tabular diagram 500 that illustrates cash network design illustrations, in accordance with an exemplary embodiment of the disclosure. The cash network design illustrates how a decision hierarchy is built across various levels, how the networks are built for each individual area, and how the network designs support various algorithm designs. The tabular diagram 500 includes columns such as a cash network decision hierarchy column 502, a starting line-item hierarchy column 504, and a starting attribute column 506. The tabular diagram 500 further includes columns such as primary cash network KPIs 508 and manual or algorithm override types columns 510.

The cash network decision hierarchy 502 includes cash projection, AR projection, AP projection, loans (non-AP liabilities) projection, investment (non-AR assets) projections, profit and loss projections (cash basis), profit and loss projection (accrual basis), sales or income projection, expense projection, COGS projections, and inventory projections. For the cash projection, the line items may be aggregated from lower-level projections, the starting attributes may include cash in and cash out, and the primary cash network KPIs may include starting cash and ending cash. Further, in this case, under the manual or algorithm override types (i.e., value or % adjustment), all available in the hierarchy may be used. Further, the prescriptive algorithm goals may include optimize cash value, optimize budget, and maximize risks.

For the AR projection, the line items may include net terms, customer, and invoice, the starting attributes may include cash in (negative for customer credits), invoice date, due date, IsRecurring, invoice amount, dilution or credit, expected payment date, IsOverdue etc., and the primary cash network KPIs may include days to collect, overdue, dilution, and total collections. Further, in this case, under the manual or algorithm override types (i.e., value or % adjustment), days to collect (DSO) and amount to collect (dilution) may be changed. Further, the prescriptive algorithm goals may aim to minimize DSO and minimize dilution.

For the AP projection, the line items may include net terms, vendor, and bill, the starting attributes may include cash out (negative for vendor credits), bill date, due date, bill amount, IsRecurring, dilution or credit, expected payment date, IsOverdue etc., and the primary cash network KPIs may include days to pay, overdue, dilution, and total payments. Further, in this case, under the manual or algorithm override types (i.e., value or % adjustment), days to pay (DPO) and amount to pay (dilution) may be changed. Further, the prescriptive algorithm goals may aim to optimize DPO.

For the loans (non-AP liabilities) projection, the line items may include balance sheet parent line item, loan type, loan name, recurring or additional (pay or borrow) activity, the starting attributes may include cash in (borrow), cash out (pay), activity date, due date, principle amt, instalment, interest, additional activity (pay or borrow), IsRecurring, IsOverdue etc., and the primary cash network KPIs may include total liabilities and total interest expense. Further, in this case, the manual or algorithm override types (i.e., value or % adjustment) may include pay amount, borrow amount, and payoff. Further, the prescriptive algorithm goals may aim to minimize interest expense and minimize total liabilities.

For the investments (non-AR assets) projection, the line items may include balance sheet parent line item, investment type, investment name, recurring or additional activity (invest or withdraw), the starting attributes may include cash in (withdraw or sell asset), cash out(invest or buy asset), maturity date, instalment, interest, investment type, additional activity(invest or withdraw), IsRecurring, IsOverdue etc., and the primary cash network KPIs may include total investments, asset purchases, and total interest income. Further, in this case, the manual or algorithm override types (i.e., value or % adjustment) may include invest amount and withdraw amount. Further, the prescriptive algorithm goals may aim to maximize interest income and maximize total assets value.

For the profit and loss projections (cash basis), the line items may include aggregate line items from profit and loss accrual converted to cash basis, the starting attributes may include cash in, cash out, quantity (qty), price per qty, days to cash, PO lead days (for COGS only) etc., and the primary cash network KPIs may include days to cash. Further, in this case, the manual or algorithm override types (i.e., value or % adjustment) may include change days to cash (DSO or DPO) and purchase order lead days (for COGS). Further, the prescriptive algorithm goals may aim to minimize cash conversion cycle (DSO+DIO−DPO).

For the profit and loss projection (accrual basis), the line items may include aggregate line items mapped to profit and loss financial statement from lower-level projections, the starting attributes may include cash in, cash out, quantity (qty), price (or cost) per qty etc., and the primary cash network KPIs may include gross profit, net profit, and profit margins. Further, in this case, the manual or algorithm override types (i.e., value or % adjustment) may include all available in the hierarchy. Further, the prescriptive algorithm goals may aim to maximize profit and profit margin.

For the sales or income projection, the line items may include profit and loss income parent line item, location, customer, product, price tier, sales person, the starting attributes may include cash in (negative for adjustment or returns), quantity (qty), quantity type (time or material), IsRecurring, price per qty, days to cash (DSO), purchase order lead time etc., and the primary cash network KPIs may include total sales or revenue by hierarchy and effective price per qty. Further, in this case, the manual or algorithm override types (i.e., value or % adjustment) may include change quantity, change price, adjust prior year sales to project, adjust prior period sales to project. Further, the prescriptive algorithm goals may aim to maximize revenue.

For the expense projection, the line items may include profit and loss expenses parent line item, vendor, expense type, price tier, the starting attributes may include cash out (negative for adjustment or returns), quantity, quantity type (time or material or other), IsRecurring, cost per qty, days to cash (DPO), return (cash value) per amount spend etc., and the primary cash network KPIs may include total expenses and return on spending. Further, in this case, the manual or algorithm override types (i.e., value or % adjustment) may include change quantity, change cost, adjust prior year expenses to project, adjust prior period expenses to project. Further, the prescriptive algorithm goals may aim to minimize costs (expenses), maximize net profit margin, and maximize returns on spending.

For the COGS projection, the line items may include profit and loss COGS parent line item, vendor, product or item, price tier, sales parent line item, the starting attributes may include cash out (negative for adjustment or returns), quantity, quantity type (time or material), IsRecurring, cost per qty, days to cash (DPO), purchase order lead time (connected to sales), cogs margin (connected to sales) etc., and the primary cash network KPIs may include total COGS by hierarchy and effective cost per qty. Further, in this case, the manual or algorithm override types (i.e., value or % adjustment) may include change quantity, change cost, change profit margin (COGS or sales). Further, the prescriptive algorithm goals may aim to minimize costs (COGS), maximize gross profit margin, and maximize utilization.

For the inventory projection, the line items may include COGS parent line item, product or item, inventory type, the starting attributes may include cash in (sales), cash out (purchase+holding), quantity, IsRecurring, price or qty, holding cost or qty, purchase cost or qty, purchase date, in stock date, sale date, days inventory outstanding (DIO), IsReturnable, IsExpirable, and the primary cash network KPIs may include total holding cost. Further, in this case, the manual or algorithm override types (i.e., value or % adjustment) may include change quantity, change price, change holding costs, and change purchase costs. Further, the prescriptive algorithm goals may aim to minimize holding costs, minimize DIO, and maximize utilization.

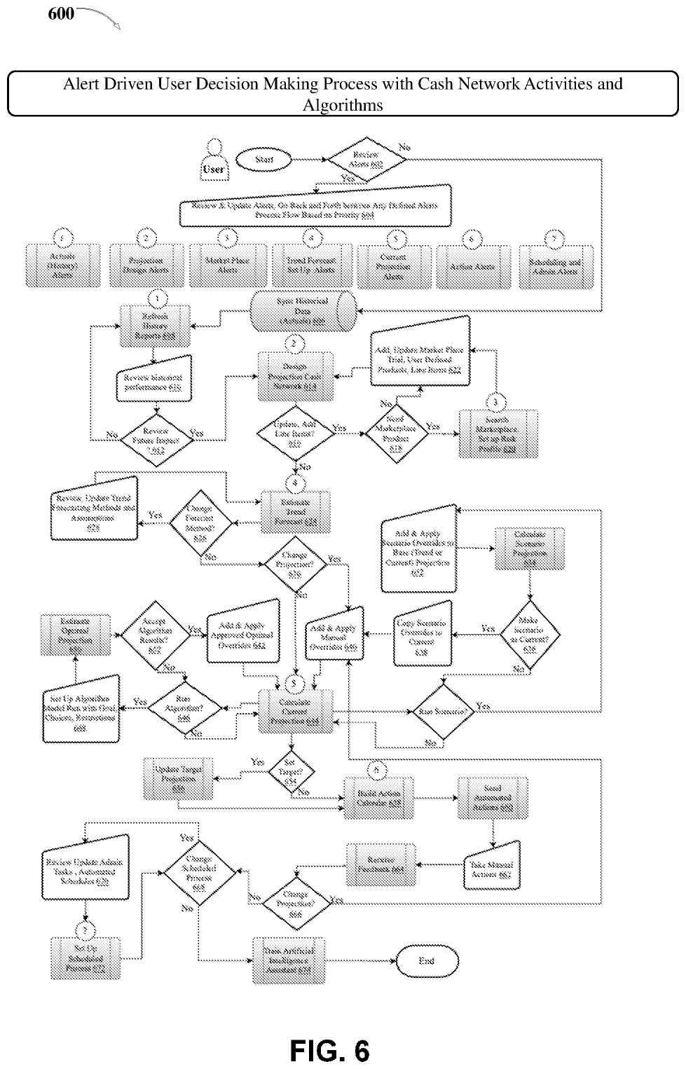

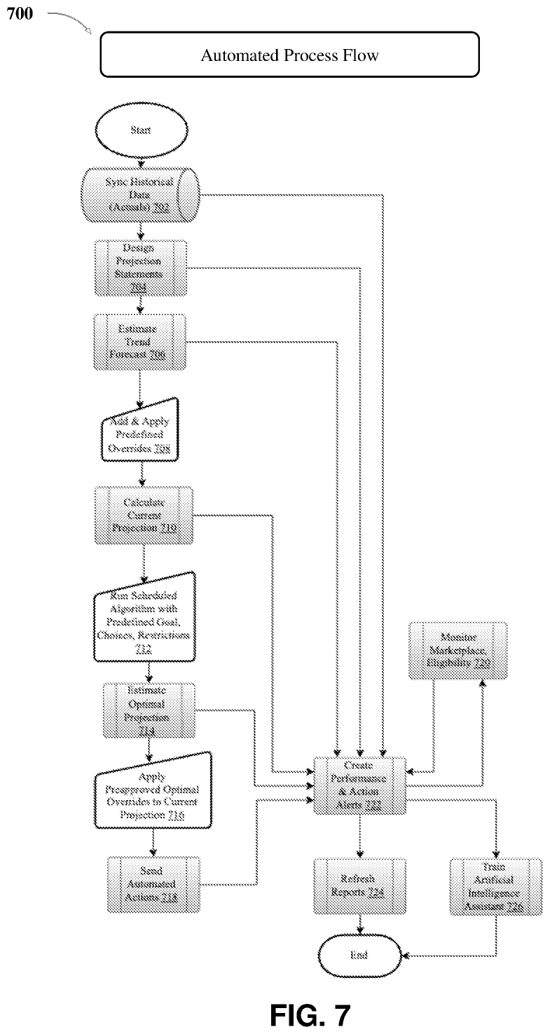

FIG. 6 is a block diagram 600 that illustrates a process to utilize the cash network algorithms in planning and decision, in accordance with an exemplary embodiment of the disclosure. Firstly, at 602, a check is performed to determine whether the alerts have been reviewed or not. In case the alerts have been reviewed, the process goes to 604, else it goes to 606. At 604, the alerts are reviewed and updated. Further, it can go back and forth between any defined alerts process flow based in priority. At 606, the historical data is synched. At 608, the history reports are refreshed. At 610, the historical performance is reviewed. At 612, a check is performed to determine whether the future impact has been reviewed or not. In case the future impact has been reviewed, the process goes to 614, else it goes to 608. At 614, the projection cash network is designed. At 616, a check is performed to determine whether the line items have been updated, added, or not. In case the line items have been updated and added, the process goes to 618, else it goes to 624. At 618, another check is performed to determine whether the marketplace product is needed, or not. In case the marketplace product is needed, the process goes to 620, else it goes to 622. At 620, the marketplace is searched, and the risk profile is setup. At 622, the marketplace trial, user defined products, and line items are added and updated. From 622, the process goes to 614. At 624, the trend forecast is estimated. At 626, a check is performed to determine whether the forecast method needs to be changed or not. In case the forecast method needs to be changed, the process goes to 628, else it goes to 630. At 628, the trend forecasting methods and assumptions are reviewed and updated. From 628, the process goes to 624. At 630, a check is performed to determine whether the projection needs to be changed or not. In case the projection needs to be changed, the process goes to 640, else it goes to 644. At 632, the scenario overrides are added and applied to base (trend or current) projection. At 634, the scenario projection is calculated. At 636, a check is performed to determine whether the scenario needs to be made as current or not. In case the scenario needs to be made as current, the process goes to 638, else it goes to the run scenario decision block, where another check is performed to determine whether the scenario needs to be run or not. In case the scenario needs to be run, the process goes to 632, else it goes to 644. At 638, the scenario overrides are copied to current. At 640, the manual overrides are added and applied, and the process goes to 644. At 642, the approved optimal overrides are added and applied, and the process goes to 644. At 644, the current projections are calculated. At 646, a check is performed to determine whether the algorithm needs to be run or not. In case the algorithm needs to be run, the process goes to 648, else it goes to 644. At 648, the algorithm model run with goal, choices, and restrictions are setup. At 650, the optimal projections are estimated. At 652, a check is performed to determine whether the algorithm results are acceptable or not. In case the algorithm results are acceptable, the process goes to 642, else it goes to 646. At 654, a check is performed to determine whether the target has been set or not. In case the target has been set, the process goes to 656, else it goes to 658. At 656, the target projection is updated the process goes to 658. At 658, the action calendar is built. At 660, the automated actions are sent. At 662, the manual actions are taken. At 664, the feedback is received. At 666, a check is performed to determine whether the projection needs to be changed or not. In case the projection needs to be changed, the process goes to 640, else it goes to 668. At 668, a check is performed to determine whether the scheduled process needs to be changed or not. In case the scheduled process needs to be changed, the process goes to 670, else it goes to 674. At 670, the admin tasks and automated schedules are reviewed and updated. At 672, the scheduled process is setup. This scheduled process feeds into automated process flow illustrated in FIG. 7. At 674, the artificial intelligence (AI) assistant is trained.

FIG. 7 is a block diagram 700 that illustrates the automated process flow, in accordance with an exemplary embodiment of the disclosure. At 702, the historical data (actuals) is synched. From 702, the process flows to 702 and 722. At 704, the projection statements are designed. From 704, the process flows to 706 and 722. At 706, the trend forecast is estimated. From 706, the process flows to 708 and 722. At 708, the predefined overrides are added and applied. At 710, the current projection is calculated. From 710, the process flows to 712 and 722. At 712, the scheduled algorithm is run with the predefined goal, choices, and restrictions. At 714, the optimal projection is estimated. From 714, the process flows to 716 and 722. At 716, the preapproved optimal overrides are applied to the current projections. At 718, the automated actions are sent. From here, the process goes to 722. At 720, the marketplace eligibility is monitored, and the process goes to 722. At 722, the performance and action alerts are created which feed into start of the manual process defined in FIG. 6 at 602. From here, the process goes to 720, 724, and 726. At 724, the reports are refreshed. At 726, the AI assistant is trained.

The optimization system described involves a cash network optimization platform that is designed to receive input data, process it, and make cash network decisions. One advantage of this system is that it uses integrated goal seeking prescriptive algorithms that optimize cash network decisions for both individual parts of the network and the entire network. This means that the system can provide better insights and suggestions for decision-making across the entire cash network. Another advantage is that the platform includes a process or workflow that provides descriptive, diagnostic, predictive, automation, and cognitive services for cash network projections, decisions, and actions. This means that users have access to a wide range of tools and services that can help them make informed decisions and take appropriate actions based on projections and insights provided by the system. Finally, the platform allows for self-service reporting, alerts, actuals, prior period actuals, trend forecast, overrides, current projection, target or budget projection, scenario projection, algorithm or optimal projection, and action calendar. This means that users have the flexibility to customize their reporting and projections, and can set alerts and take actions based on real-time data and projections. The optimization system includes the integration of an external vendor marketplace that supports decision making for new and updated financial and operating products. This marketplace can help the user to evaluate and monitor relevant products inside the cash network before and after purchasing them. By doing so, the user can make better-informed decisions about which products to invest in, which can help optimize their cash network. For example, let us say that a company is looking to purchase a new software system to improve their supply chain management. The optimization system can connect to the external vendor marketplace, which allows the company to evaluate different software options, compare features and prices, and see how similar products have performed within their cash network. After purchasing the software, the system can continue to monitor its performance and provide insights on how it's impacting the company's cash network.

The optimization system discussed here has the ability to send output data to multiple systems and processes that are responsible for taking action, executing plans and implementing decisions. This output data can be sent automatically from the assigned computing devices, or it can be downloaded manually by individuals or enterprise entities. For instance, an accounting software system can receive the optimized cash projection figures and use them to create financial statements, track expenses, and perform other accounting functions. Similarly, the production application can receive the optimized cash projections to plan for raw materials, production schedules, and workforce requirements. The data warehouse financial accounts can be updated with the latest financial information, including cash projections, and make it available for analysis and reporting. For example, suppose a retail company uses an optimization system to optimize its cash network decisions, including projections and cash values. The optimization system can send the optimized cash projection data to the accounting software system for generating accurate financial statements, tracking expenses, and monitoring cash flow. The production application can use the optimized cash projection data to plan for production schedules, workforce requirements, and raw materials. The data warehouse financial accounts can store the optimized cash projection data and make it available for analysis and reporting, allowing the company to make data-driven decisions for better financial performance.

The optimization system allows a user to have a high level of control and customization over their cash network. The user can evaluate products inside the cash network, monitor current performance and alerts, and set minimum and maximum cash or cash value budgets or targets for every line item in the cash network. This enables the user to manage their cash network in a more efficient and effective way. Additionally, the user can manage the cash network projection decision planning process using overrides, what-if scenarios, algorithms, and an action calendar. Overrides allow the user to manually adjust projections and targets, based on their own knowledge and experience. What-if scenarios allow the user to test out different hypothetical scenarios and see how they would impact the cash network. Algorithms can provide recommendations for optimal decision-making based on historical data or other factors. The action calendar allows the user to schedule specific actions or decisions to be made at specific times, which can help ensure that the cash network is managed effectively and efficiently. For example, imagine a business owner who wants to optimize their cash network. They use the optimization system to customize their cash network, set minimum and maximum budgets for each line item, and monitor current performance and alerts. They then use what-if scenarios to test out different scenarios, such as what would happen if they reduced spending on a particular area of the cash network. Based on the results of the what-if scenarios and recommendations from the system's algorithms, they adjust their projections and targets. They also use the action calendar to schedule specific actions and decisions, such as when to make payments or adjust budgets. This enables the business owner to effectively manage their cash network and make data-driven decisions.

The optimization system allows for three types of overrides, manual overrides, what-if scenario overrides, and algorithm-recommended optimal overrides. Manual overrides are changes made to the cash network projection by the user, and can be used to update assumptions and plan actions. For example, a user may manually override the projected revenue for a particular product line based on new market research, which would then impact the projected cash flow for that line. What-if scenario overrides allow the user to test out different scenarios by changing the assumptions in the projection. For example, a user could create a what-if scenario where they increase their marketing spend by 50%, and then evaluate the impact on their projected cash flow. Algorithm-recommended optimal overrides use the integrated prescriptive algorithms to recommend changes to the cash network projection based on the user's input and desired outcomes. For example, the system may recommend reducing inventory levels in a particular product line to optimize cash flow, which the user can then choose to implement or not. These override types provide flexibility for the user to adjust and optimize their cash network projection and decision-making process.

The optimization system described allows the user to override current projections and planned actions as previously set. This means that the user has the flexibility to change their assumptions or plans at any time, based on new information or changing circumstances. For example, if a company sets a cash target for a particular period but then experiences unexpected expenses, they may want to override their original projection and adjust their target accordingly. Additionally, the optimization system allows the user to run what-if scenarios across the cash network hierarchy to perform impact analytics and obtain scenario results. This means that the user can test different assumptions and see how they would impact the overall cash network before making a decision. For example, a company may want to test the impact of increasing their advertising spend on their cash flow projections, or the impact of delaying payments to suppliers. By providing these override and scenario analysis capabilities, the optimization system allows the user to make more informed and agile decisions, based on the most up-to-date information available. This can help them to optimize their cash network and achieve their financial goals more effectively. The optimization system allows users to select an algorithm template and run and schedule model runs to obtain recommendations for selectively overriding current projections and planned actions as previously set. An algorithm template is a pre-configured algorithm designed to address a specific problem or achieve a specific goal. The cash network optimization platform allows the user to select an algorithm template that suits their needs. The algorithm templates have inputs such as goals, objectives, choices, decision variables, parameters, restrictions, and constraints. These inputs are used to create a model of the cash network and the optimization problem. The user can then run and schedule model runs using the algorithm template to obtain recommendations for selectively overriding current projections and planned actions. For example, a user may select an algorithm template for optimizing inventory levels in their cash network. The user can input the goals, objectives, choices, decision variables, parameters, restrictions, and constraints specific to their inventory management problem. The cash network optimization platform will then run the model using the algorithm template and provide recommendations for optimizing inventory levels. The user can selectively override current projections and planned actions as previously set based on the recommendations provided by the platform. Another example of an algorithm template is for optimizing cash flow management. The user can input the goals, objectives, choices, decision variables, parameters, restrictions, and constraints specific to their cash flow management problem. The cash network optimization platform will then run the model using the algorithm template and provide recommendations for optimizing cash flow management. The user can selectively override current projections and planned actions as previously set based on the recommendations provided by the platform. Overall, the ability to select an algorithm template, run and schedule model runs, and obtain recommendations for selectively overriding current projections and planned actions provides users with a powerful tool for optimizing their cash network.

The optimization system includes a cash network optimization platform that offers various features to optimize business projections and improve financial decision-making One of the key features of the platform is customizable prebuilt business projection cash networks that allow users to modify and customize the cash network to suit their specific needs. For example, a company may have a prebuilt cash network for managing their inventory. The cash network may include line-item hierarchy, attributes, activities, time periods, performance indicators, and override types specific to managing inventory. The user can customize the prebuilt cash network by changing the line-item hierarchy, attributes, and performance indicators to reflect their company's inventory management practices. The cash network optimization platform also includes prescriptive algorithms formulations for various financial aspects, including cash flow, accounts receivable, accounts payable, investments or assets, loans or liabilities, profit and loss, sales, costs (COGS—cost of goods sold, cost of sales), expenses, marketing expense, workforce expense, and inventory. These algorithms use data and analytics to generate recommendations that can help businesses optimize their financial performance For example, a company may use the prescriptive algorithm for cash flow to optimize their cash inflows and outflows. The algorithm may suggest actions such as delaying payments to suppliers or accelerating collections from customers to improve cash flow. Similarly, the prescriptive algorithm for inventory may suggest optimal levels of inventory to maintain based on historical sales data and lead times from suppliers. In addition to the prebuilt cash networks and prescriptive algorithms, the cash network optimization platform allows users to design new cash networks and algorithms for enterprise value and resource optimization. This feature enables businesses to create custom cash networks that are tailored to their unique needs and objectives. For example, a company may design a new cash network to optimize their marketing expenses. The cash network may include line-items such as advertising, promotions, and sponsorships, and the algorithm may use data on past marketing campaigns to generate recommendations on optimal spending levels for each line-item.

The optimization system allows users to create customized personal projection cash networks and prescriptive algorithms that help to manage their personal finances effectively. Some of the customizable prebuilt personal projection cash networks and prescriptive algorithms that can be utilized by the platform include:
1. Cash flow: The cash flow network helps users to manage their cash inflows and outflows. The algorithm can be designed to analyze income, expenses, and savings to provide a projection of future cash flow.
2. Account receivable: The account receivable network helps users to manage money they have lent out to others. The algorithm can be designed to track repayment schedules and provide projections of future payments.
3. Accounts payable: The accounts payable network helps users to manage money they owe to others. The algorithm can be designed to optimize repayment schedules and provide projections of future payments.
4. Investments or assets: The investments or assets network helps users to manage their investments and assets. The algorithm can be designed to provide projections of future growth or decline in investment value.
5. Loans or liabilities: The loans or liabilities network helps users to manage their loans and liabilities. The algorithm can be designed to optimize repayment schedules and provide projections of future payments.
6. Profit & loss: The profit & loss network helps users to manage their income and expenses. The algorithm can be designed to analyze income sources and expenses to provide a projection of future profits or losses.
7. Employment income: The employment income network helps users to manage their employment income. The algorithm can be designed to provide a projection of future income based on salary and benefits.
8. Costs: The costs network helps users to manage their cost of living expenses. The algorithm can be designed to track expenses and provide a projection of future costs.
9. Expenses: The expenses network helps users to manage their various expenses, such as recreation, shopping, and health expenses. The algorithm can be designed to track expenses and provide a projection of future costs.
10. Personal net worth: The personal net worth network helps users to manage their overall financial situation. The algorithm can be designed to analyze all income, assets, and liabilities simultaneously to provide a projection of future net worth.

Users can also design new cash networks and algorithms to optimize their personal finances based on their specific needs and goals. The platform provides self-service reporting, alerts, and trend forecasts to assist users in making informed decisions about their finances.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, an integrated cash network decision optimization platform. While various exemplary embodiments of the disclosed application have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. An optimization system, comprising:
a cash network optimization platform that has been built using cash network designs which include line-item hierarchy, attributes, activities, time periods, performance indicators, and override types, and is configured to receive input data that is processed for making cash network decisions,
wherein the cash network decisions are optimized using integrated goal seeking prescriptive algorithms for individual part of cash network as well as across entire cash network, and
wherein a process or workflow is integrated to provide descriptive, diagnostic, predictive, automation, and cognitive services along with prescriptive algorithms for the cash network projections, decisions, and actions using self-service reporting, alerts, actuals, prior period actuals, trend forecast, overrides, current projection, target or budget projection, scenario projection, algorithm or optimal projection, and action calendar.

2. The optimization system of claim 1, further comprising a self-learning and contextual AI (Artificial Intelligence) assistant built using large language models (LLM) that has been integrated to execute, generate usable content on the accessible data, guide, and interact with user through the entire projection and decision planning process using voice and chat.

3. The optimization system of claim 1, wherein an external vendor marketplace has been integrated to support decision making for new and updated financial and operating products by evaluating and monitoring relevant products inside the cash network before and after purchasing them.

4. The optimization system of claim 1, wherein the cash network optimization platform has been built and designed to perform self-service reporting with one or more set up alerts, out of range alerts, comparison alerts, and anomaly detection.

5. The optimization system of claim 1, wherein the cash network optimization platform has been built and designed to perform cash network activity trend forecasting using growth ratios, timeseries algorithms, financial calculators, and regression.

6. The optimization system of claim 1, wherein the cash network optimization platform has been further built and designed to optimize the entire cash network or individual areas of cash network using customizable algorithm templates solved using mathematical optimization and machine learning.

7. The optimization system of claim 1, wherein the cash network optimization platform is configured to receive the input data from one or more input sources, either automatically from assigned computing devices or manually as uploaded by one or more individual or enterprise entities.

8. The optimization system of claim 1, wherein the cash network optimization platform is configured to send output data to one or more action, execution and implementation systems and processes, either automatically from assigned computing devices or manually as downloaded by one or more individual or enterprise entities.

9. The optimization system of claim 1, wherein the cash network optimization platform allows a user to customize cash networks, evaluate products inside cash network, monitor current performance and alerts, set minimum, maximum cash or cash value budgets or targets for every line item in the cash network and manage cash network projection decision planning process using overrides, what if scenario, algorithms, and action calendar.

10. The optimization system of claim 9, wherein the cash network optimization platform is configured to facilitate manual overrides, what if scenario overrides, and algorithm recommended optimal overrides using same override types for each cash network projection to change assumptions, to take decisions and to plan actions.

11. The optimization system of claim 10, wherein the cash network optimization platform further allows the user to directly override current projections and planned actions as previously set.

12. The optimization system of claim 10, wherein the cash network optimization platform allows user to run what if scenario across the cash network hierarchy to perform impact analytics and obtain scenario results to override current projections and planned actions as previously set.

13. The optimization system of claim 10, wherein the cash network optimization platform allows user to select an algorithm template, run and schedule model runs using goals, objectives, choices, decision variables, parameters, restrictions, constraints and obtain recommendations to selectively override current projections and planned actions as previously set.

14. The optimization system of claim 1, wherein features of the cash network optimization platform include at least:
Cash Network Designs: Built-in customizable cash, cash value projections, goals with projection hierarchy, line-item hierarchy, attributes, performance indicators, override types,
Cash Decision Optimization Algorithms Templates: built-in customizable business and personal formulations using algorithms for each level of decision hierarchy,
Reconciliation of Cash Decisions: connect decision algorithms and decisions at various levels of hierarchy with both bottom up and top-down approach,
Integrating Cash Projections Design, Scenarios, Cash value Algorithms, and Cash value
Performance process, and
Planning and Execution System Integrations: integrate with accounting, data warehouse financial accounts, and production applications using custom built data connectors and file transfers to send decisions and receive data.

15. The optimization system of claim 1, wherein features of the cash network optimization platform include customizable prebuilt business projection cash networks and prescriptive algorithms formulations for cash flow, account receivable, accounts payable, investments or assets, loans or liabilities, profit & loss, sales, costs, expenses, marketing expense, workforce expense and inventory, and ability to design new cash networks and algorithms for enterprise value and resource optimization.

16. The optimization system of claim 1, wherein features of the cash network optimization platform include customizable prebuilt personal projection cash networks and prescriptive algorithms formulations for cash flow, account receivable, accounts payable, investments or assets, loans or liabilities, profit & loss, employment income, costs, expenses, recreation expense, shopping expense and health expenses, and ability to design new cash networks and algorithms for personal net worth and resource optimization.
